(19) United States
(12) Patent Application Publication
(10) Pub. No.: US 2014/0314351 A1
(43) Pub. Date: Oct. 23, 2014

(54) FLUID DYNAMIC PRESSURE BEARING OIL, FLUID DYNAMIC PRESSURE BEARING USING THE SAME, AND SPINDLE MOTOR

(71) Applicant: Minebea Co., Ltd., Kitasaku-gun (JP)

(72) Inventors: Hideo FUJIURA, Saku-shi (JP); Jun HATCHO, Kitasaku-gun (JP)

(21) Appl. No.: 14/228,922

(22) Filed: Mar. 28, 2014

(30) Foreign Application Priority Data
Mar. 28, 2013 (JP) 2013-68778
Mar. 28, 2014 (JP) 2014-069784

(51) Int. Cl. F16C 32/06; C10M 105/36

(52) U.S. Cl. CPC F16C 32/0659; C10M 105/36; C10M 2207/2835; C10M 137/04
USPC 384/120; 508/485; 508/423; 508/440

(57) ABSTRACT

It is provided a long life spindle motor that is excellent in startup characteristic in low-temperature environments such as 0° C., and that startup problems due to the evaporation or deterioration of lubricating oil can be avoided in high-temperature environments. The spindle motor includes a fluid dynamic bearing filled with a lubricating oil, containing a methyl pentanediol diester obtained by esterifying 3-methyl-1,5-pentanediol with n-decanoic acid and n-undecanoic acid at a molar ratio ranging from 90:10 to 20:80, and having a water content of not more than 1000 ppm.

### BACKGROUND OF THE INVENTION

1. Field of the Invention

The present invention relates to a fluid dynamic bearing and a spindle motor using a lubricating oil that has low volatility and does not freeze even in a 0° C. environment.

2. Description of the Related Art

Recently, demand for hard disk drives for servers storing enormous amount of data has been rapidly growing with the development of information equipment. The amount of data in the world is expected to double in just a few years. In such circumstances, in order to secure enough area for server facilities that are becoming enormous, installation of server facilities in more remote locations and even in severe environment regions such as extremely cold regions like Alaska and tropical regions like the Amazon region has been contemplated.

It is generally desired that the room where a server facility is installed be air-conditioned, but keeping constant temperature in the environments as mentioned above requires huge running cost. Therefore, spindle motors for hard disk drives that can be used in low-temperature environments or high-temperature environments have been sought.

For example, Japanese Patent Application Publication No. 2004-084839 (hereinafter referred to as Patent Document 1) and Japanese Patent Application Publication No. 2005-290256 (hereinafter referred to as Patent Document 2) disclose a spindle motor with a fluid bearing device that can rotate at low torque and in a low-temperature region by using a lubricating oil including a particular ester as a base oil.

In addition, with miniaturization of hard disk drives, it has become difficult to provide a sufficient lubricating oil reservoir in a spindle motor used therein. Therefore, lubricating oils with less evaporation even in high-temperature environments has been sought.

### SUMMARY OF THE INVENTION

Most of lubricating oils used so far in fluid dynamic bearings for hard disk drives include ester compounds having low viscosity and low volatility as base oils. However, it has been pointed out that lubricating oils with improved volatility generally suffer significant deterioration in flowability in low-temperature environments. A spindle motor with such lubricating oil is likely to become unable to rotate even in the vicinity of 0° C.

The spindle motors described in, for example, Patent Document 1 and Patent Document 2 have a good startup characteristic in low-temperature environments. However, it is difficult to obtain a sufficient product lifetime because the amount of evaporation of the lubricating oil used therein is large in high-temperature environments.

The present invention was made in view of the foregoing situation and provides a spindle motor that is excellent in startup characteristic in low-temperature environments, for example, at 0° C., and that the possibility of being unable to start due to evaporation and/or deterioration of lubricating oil can be avoided even in high-temperature environments, so that the product lifetime is increased.

### Means for Solving the Problem

The use of diester oils obtained from fatty acids having 10 or more carbon atoms as a base oil has been avoided due to its likeliness of freezing. However, the inventors of the present invention have made elaborate studies in order to achieve the aforementioned object and found that diester oils for a base oil of lubricating oil with good low-temperature flowability and volatility resistance can be obtained by combining particular fatty acids having 10 or more carbon atoms at a particular ratio. The inventors of the present invention have also found that degradation of the base oil of lubricating oil in high-temperature environments can be suppressed by controlling the water content in the diester oil.

The inventors of the present invention have found that such base oil of lubricating oil can be used in a spindle motor to provide a spindle motor that is excellent in startup characteristics in low-temperature environments and has a long lifetime even in high-temperature environments. These findings have led to completion of the invention.

Specifically, the present invention relates to a fluid dynamic bearing comprising: a dynamic pressure groove on a facing surface of at least one of a rotating member and a fixed member facing each other with a predetermined gap therebetween filled with a lubricating oil, and to a spindle motor comprising the fluid dynamic bearing, in which the lubricating oil contains a methyl pentanediol diester obtained by esterifying 3-methyl-1,5-pentanediol with a fatty acid including n-decanoic acid and n-undecanoic acid at a molar ratio ranging from 90:10 to 20:80, and the lubricating oil has a water content of not more than 1000 ppm.

The present invention also relates to a fluid dynamic bearing comprising: a dynamic pressure groove on a facing surface of at least one of a rotating member and a fixed member facing each other with a predetermined gap therebetween filled with a lubricating oil, and to a spindle motor including the fluid dynamic bearing, in which the lubricating oil contains a methyl pentanediol diester obtained by esterifying 3-methyl-1,5-pentanediol with a fatty acid including n-decanoic acid and n-undecanoic acid at a molar ratio ranging from 90:10 to 20:80, and 0.1% to 5% by mass of an extreme-pressure additive with respect to the whole quantity of the lubricating oil, and the lubricating oil has a water content in ppm of not more than an upper limit value y represented by Expression (1):

y=912.47x^{-0.449} (1)

y: the upper limit value of the water content (ppm) in the lubricating oil

x: the amount of the extreme-pressure additive contained in the lubricating oil (in % by mass with respect to the whole quantity of the lubricating oil).

In the present invention, it is preferable that the amount of the extreme-pressure additive contained be 0.3% to 5% by mass with respect to the whole quantity of the lubricating oil.

In particular, it is preferable that a relationship between the amount of the extreme-pressure additive contained in the lubricating oil and the water content in the lubricating oil satisfy one of conditions (a) to (c) below:

(a) the amount of the extreme-pressure additive contained is not more than 0.8% by mass and the water content in the lubricating oil is not more than 1000 ppm;

(b) the amount of the extreme-pressure additive contained is not more than 3% by mass and the water content in the lubricating oil is not more than 500 ppm; and

(c) the amount of the extreme-pressure additive contained is not more than 5% by mass and the water content in the lubricating oil is not more than 300 ppm.

Specifically, the extreme-pressure additive is preferably a phosphorous-based extreme-pressure additive.

In the present invention, the molar ratio between n-decanoic acid and n-undecanoic acid preferably ranges from 30:70 to 70:30, and more particularly, the molar ratio between n-decanoic acid and n-undecanoic acid is set at 50:50.

The present invention also relates to a lubricating oil for fluid dynamic bearing comprising: a methyl pentanediol diester obtained by esterifying 3-methyl-1,5-pentanediol with a fatty acid, in which the fatty acid includes n-decanoic acid and n-undecanoic acid at a molar ratio ranging from 90:10 to 20:80, and the lubricating oil has a water content of not more than 1000 ppm.

The present invention further relates to a lubricating oil for fluid dynamic bearing comprising: a methyl pentanediol diester obtained by esterifying 3-methyl-1,5-pentanediol with a fatty acid; and an extreme-pressure additive, in which the fatty acid includes n-decanoic acid and n-undecanoic acid at a molar ratio ranging from 90:10 to 20:80, the amount of the extreme-pressure additive contained is 0.1% to 5% by mass with respect to the whole quantity of the lubricating oil, and the lubricating oil has a water content in ppm of not more than an upper limit value y represented by Expression (1):

y=912.47x^{-0.449} (1)

y: the upper limit value of the water content (ppm) in the lubricating oil

x: the amount of the extreme-pressure additive contained in the lubricating oil (in % by mass with respect to the whole quantity of the lubricating oil).

In the lubricating oil for fluid dynamic bearing of the present invention, it is preferable that the amount of the extreme-pressure additive contained be 0.3% to 5% by mass with respect to the whole quantity of the lubricating oil.

In particular, it is preferable that a relationship between the amount of the extreme-pressure additive contained in the lubricating oil and the water content in the lubricating oil satisfy one of conditions (a) to (c) below:

(a) the amount of the extreme-pressure additive contained is not more than 0.8% by mass and the water content in the lubricating oil is not more than 1000 ppm;

(b) the amount of the extreme-pressure additive contained is not more than 3% by mass and the water content in the lubricating oil is not more than 500 ppm; and

(c) the amount of the extreme-pressure additive contained is not more than 5% by mass and the water content in the lubricating oil is not more than 300 ppm.

Specifically, the extreme-pressure additive is preferably a phosphorous-based extreme-pressure additive.

### Effects of the Invention

In the present invention, the base oil of the lubricating oil used is composed of a methyl pentanediol diester obtained by esterifying 3-methyl-1,5-pentanediol as a dihydric alcohol with a fatty acid including n-decanoic acid and n-undecanoic acid. Here, the molar ratio between n-decanoic acid and n-undecanoic acid is controlled in a particular numerical range, and the water content in the lubricating oil is specified. Furthermore, a predetermined amount of an extreme-pressure additive is blended into the lubricating oil in addition to the base oil, and the water content in the lubricating oil is limited as a function of the amount of the extreme-pressure additive. Accordingly, the resulting lubricating oil has good low-temperature flowability and, in addition, evaporation and degradation at high temperatures can be prevented.

Accordingly, the spindle motor including the fluid dynamic bearing of the present invention using the lubricating oil as described above is excellent in startup characteristic in low-temperature (0° C. or lower) environments, and a stop of the device due to evaporation or degradation of the lubricating oil can be suppressed even in high-temperature environments. Moreover, a variation (deterioration) in shaft rigidity of the spindle motor is suppressed even after long-term use, and the spindle motor has a long lifetime.

### BRIEF DESCRIPTION OF THE DRAWINGS

FIG. 1 is a conceptual diagram illustrating a main part structure of a spindle motor according to the present invention;

FIG. 2 is a graph showing variations in composition ratio of diester oils with respect to the mixing ratio (% by mole) of n-undecanoic acid (nC11 acid);

FIG. 3 is a graph showing the results of measurement of total acid number after leaving diester oil (base oil of lubricating oil) with different water contents in an 80° C. environment for a specified time;

FIG. 4 is a graph showing variations in melting point and amount of evaporation of a lubricating oil with respect to the mixing ratio (% by mole) of n-undecanoic acid (nC11 acid) of the base oil used in the lubricating oil;

FIG. 5 is a graph showing evaluations of increase in total acid number relative to samples left in an 80° C. environment for a specified time, in which the water content (vertical axis) in a lubricating oil was adjusted with respect to the addition amount (horizontal axis) of the extreme-pressure additive A included in the lubricating oil; and

FIG. 6 is a graph showing evaluations of increase in total acid number relative to samples left in an 80° C. environment for a specified time, in which the water content (vertical axis) in a lubricating oil was adjusted with respect to the addition amount (horizontal axis) of the extreme-pressure additive B included in the lubricating oil.

### DETAILED DESCRIPTION OF THE PREFERRED EMBODIMENTS

Ester oils conventionally proposed such as ester oil obtained from 3-methyl-1,5-pentanediol, for example, are characterized by having low viscosity and low volatility. However, when the aliphatic monocarboxylic acid used in preparation of such ester oils has a larger number of carbon atoms, specifically, when it is a long-chain fatty acid equal to or longer than n-decanoic acid (nC10 acid), the resultant ester oil is likely to freeze, and for example, may freeze in a 0° C. environment. Considering a variety of operating environments, an ester oil obtained from 3-methyl-1,5-pentanediol and a long-chain fatty acid equal to or longer than n-decanoic acid (nC10 acid) have been considered to be inappropriate for the use as lubricating oil of a fluid dynamic bearing for hard disk drive.

The inventors of the present invention found that a diester oil synthesized by mixing n-decanoic acid (nC10 acid) and n-undecanoic acid (nC11 acid) at a particular ratio has a freezing point shifted to a lower temperature, and that the diester oil is improved in volatility becoming more difficult to evaporate even at high temperatures. The inventors of the present invention have applied this finding to spindle motors to complete the present invention.

Modes for carrying out the present invention (hereinafter called “embodiments”) will be described in detail below with reference to the accompanying drawings.

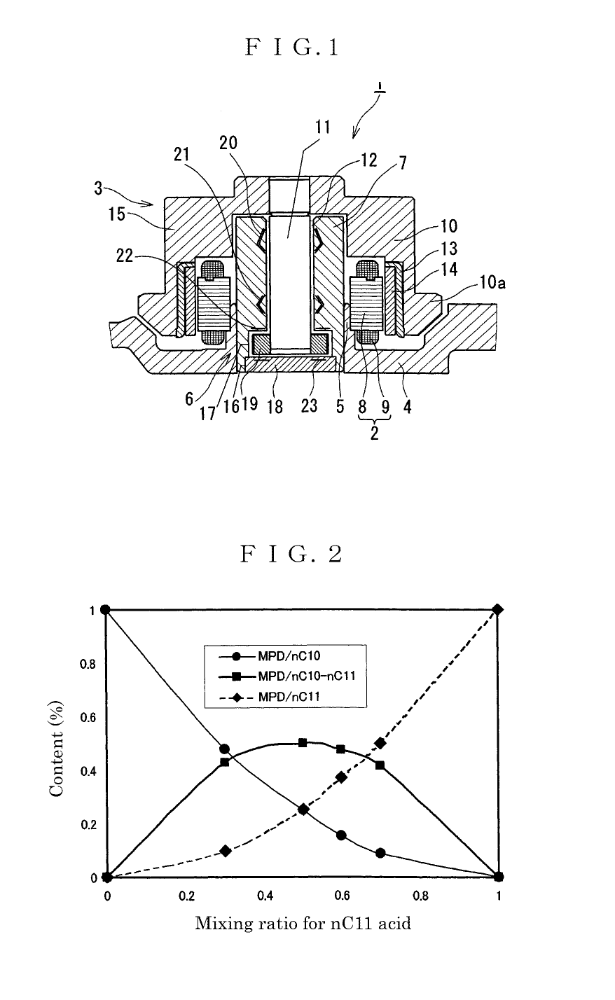

FIG. 1 is a schematic diagram illustrating a fluid dynamic bearing according to an embodiment of the present invention and a spindle motor provided with such fluid dynamic bearing. It should be noted that the embodiments shown below are preferred embodiments of the present invention and the present invention is not limited thereto.

As shown in FIG. 1, a spindle motor 1 is used as a motor for driving a data storage device including a magnetic disk, an optical disk, or other media for use in computers. In general, the spindle motor is configured with a stator assembly 2 and a rotor assembly 3 as a whole. Although the spindle motor 1 in FIG. 1 is a rotary-shaft motor, the present invention is also applicable to a fixed-shaft motor.

The stator assembly 2 is fixed to a cylindrical portion 5 protruding upwardly that is provided in a housing 4 (base plate) constituting a casing for the data storage device. A stator core 8 having a stator coil 9 wound thereon is fitted on the outer periphery of the cylindrical portion 5.

The rotor assembly 3 has a rotor hub 10. The rotor hub 10 is fixed to an upper end of a shaft 11 and rotates together with the shaft 11. The shaft 11 is inserted in a sleeve 7 serving as a bearing member and is rotatably supported by the sleeve 7. The sleeve 7 is fitted in the inside of the cylindrical portion 5 and fixed thereto. A lower cylindrical portion 10a of the rotor hub 10 rotates in the inside of the housing 4. A back yoke 13 is mounted on the inner peripheral surface of the lower cylindrical portion 10a. A rotor magnet 14 is fitted in and fixed to the inside of the back yoke 13 and magnetized to a plurality of poles including the north poles and the south poles.

When the stator coil 9 is energized, the stator core 8 forms a magnetic field. This magnetic field acts on the rotor magnet 14 arranged in the magnetic field to rotate the rotor assembly 3. A recording disk serving as a storage of the data storage device, for example a magnetic disk (not shown), is mounted on the outer peripheral surface of an intermediate cylindrical portion 15 of the rotor hub 10 of the rotor assembly 3 and is rotated or stopped by operation of the spindle motor 1, whereby a recording head (not shown) performs writing of information and data processing.

In the spindle motor 1 of the embodiment described above, a fluid dynamic bearing 6 is provided in the part where the sleeve 7 rotatably supports the shaft 11.

A large-diameter first recess 16 opening downward is formed at the lower end of the sleeve 7, and a small-diameter second recess 17 is additionally formed on the top surface of the first recess 16. A counter plate (thrust receiving plate) 18 is fitted in the large-diameter first recess 16 and fixed thereto by welding, bonding, or other means so that the sleeve 7 is hermetically sealed.

A thrust washer 19 is press-fitted to be fixed to the lower end of the shaft 11. This thrust washer 19 is arranged in the second recess 17 of the sleeve 7 so as to face the counter plate 18 and the top surface of the second recess 17 and rotate together with the shaft 11.

The gap between the sleeve 7 and the shaft 11, the gap between the thrust washer 19 and the second recess 17, and the gap between the thrust washer 19 and the shaft 11 and the counter plate 18 are in communication with each other. These communicative gaps are filled with a lubricating oil 12 described later. The lubricating oil 12 is filled from the gap between the sleeve 7 and the shaft 11.

On the inner peripheral surface of the sleeve 7 that faces the shaft 11, a first radial dynamic pressure groove 20 and a second radial dynamic pressure groove 21 for generating dynamic pressure are formed apart from each other in the axial direction. The radial dynamic pressure grooves 20 and 21 generate dynamic pressure by rotation of the shaft 11 to bring the shaft 11 and the sleeve 7 into a non-contact state in the radial direction. A first thrust dynamic pressure groove 22 and a second thrust dynamic pressure groove 23 are formed on the top surface of the second recess 17 that faces the upper end surface of the thrust washer 19 and the upper end surface of the counter plate 18 that faces the lower end surface of the thrust washer 19, respectively. The thrust dynamic pressure grooves 22 and 23 generate dynamic pressure for stably floating the shaft 11 in the thrust direction, by rotation of the shaft 11. The action of these dynamic pressure grooves allows the shaft 11 to rotate stably at high speed in a non-contact state with the sleeve 7. Conventional groove patterns such as herringbone grooves and spiral grooves may be used as the dynamic pressure grooves.

The lubricating oil for use in the fluid dynamic bearing and the spindle motor of the present invention contains, as a base oil, a methyl pentanediol diester obtained by esterifying 3-methyl-1,5-pentanediol with a fatty acid including n-decanoic acid and n-undecanoic acid mixed at a molar ratio ranging from 90:10 to 20:80. The lubricating oil is characterized by having a water content of not more than 1000 ppm. It should be noted that the lubricating oil itself, that is, the lubricating oil for fluid dynamic bearings is also a subject of the present invention.

With respect to the fatty acid used in the esterification, the molar ratio of n-decanoic acid and n-undecanoic acid is preferably 30:70 to 70:30, and more preferably 50:50. By using two kinds of fatty acids with such a ratio, the resulting diester oil (base oil) can achieve both flowability at low temperatures and low volatility at high temperatures.

Preferably, the lubricating oil has a water content of not more than 500 ppm. The water content controlled in a preferable numerical range improves the flowability at low temperatures, that is, improves the startup characteristic of the spindle motor using the lubricating oil with the above described base oil, and, in addition, can reduce degradation of the lubricating oil due to oxidation of the ester oil especially in high-temperature environments, leading to product stability of the fluid dynamic bearing using the present lubricating oil and the spindle motor including such fluid dynamic bearing. More precisely, the preferred water content in the lubricating oil may slightly vary depending on whether an extreme-pressure additive is blended as described later.

The production method for the diester oil is not limited to a particular method, and conventionally known production methods can be used.

For example, 3-methyl-1,5-pentanediol may be esterified with the above two kinds of fatty acids in the presence of an esterification catalyst, followed by purification. In the esterification, in general, the two kinds of fatty acids are used in the proportion of 2.0 moles to 3.0 moles, in total, for each 1 mole of 3-methyl-1,5-pentanediol.

Examples of the esterification catalyst used here include Lewis acids such as aluminium derivatives, tin derivatives, and titanium derivatives; and sulfonic acid derivatives such as p-toluenesulfonic acid, methanesulfonic acid, and sulfuric acid. The amount of the esterification catalyst used is generally about 0.01% to 5.0% by mass with respect to the total mass of 3-methyl-1,5-pentanediol and the above two kinds of fatty acids.

The esterification is preferably performed in the presence of an inert gas at reaction temperatures of generally 120° C. to 250° C., preferably 140° C. to 230° C., for a reaction duration of generally 3 to 30 hours. The produced water may be azeotropically distilled away from the system using a water entrainer such as benzene, toluene, xylenes, or cyclohexane, if necessary.

After completion of the esterification, an excess of the raw material is distilled away under a reduced pressure or normal pressure and purified by a conventional common purification process (for example, neutralization, washing, extraction, reduced-pressure distillation, or adsorption distillation) to obtain the target 3-methyl-1,5-pentanediol diester.

The lubricating oil (the lubricating oil for fluid dynamic bearing according to the present invention) for use in the fluid dynamic bearing and the spindle motor of the present invention may contain 0.1% to 5% by mass, preferably 0.3% to 5% by mass, of an extreme-pressure additive with respect to the whole quantity of the lubricating oil, in addition to the methyl pentanediol diester as a base oil.

In the case where the lubricating oil contains an extreme-pressure additive, the water content in the lubricating oil is defined such that the water content in ppm is not more than an upper limit value y represented by Expression (1) below.

Here, x is the numerical value represented by [(mass of extreme-pressure additive/total mass of lubricating oil)×100].

y=912.47x^{-0.449} (1)

y: upper limit value of water content (ppm) included in the lubricating oil

x: amount of extreme-pressure additive contained in the lubricating oil (in % by mass with respect to the whole quantity of the lubricating oil)

In this case, it is preferable that the relationship between the amount of the extreme-pressure additive contained and the water content in the lubricating oil satisfy one of conditions (a) to (c) below:

(a) the amount of the extreme-pressure additive contained is not more than 0.8% by mass and the water content in the lubricating oil is not more than 1000 ppm;

(b) the amount of the extreme-pressure additive contained is not more than 3% by mass and the water content in the lubricating oil is not more than 500 ppm; and

(c) the amount of the extreme-pressure additive contained is not more than 5% by mass and the water content in the lubricating oil is not more than 300 ppm.

Conventionally known additives including sulfur, chlorine, phosphorus, or other substances may be used as the extreme-pressure additive blended in the lubricating oil for fluid dynamic bearings of the present invention. Among these, preferably, phosphorus-based extreme-pressure additives such as phosphoric acid esters, phosphorous acid esters, and acid phosphoric acid ester amine salts can be used.

The lubricating oil for use in the fluid dynamic bearing and the spindle motor of the present invention may include, in addition to the base oil or the base oil and the extreme-pressure additive, a base oil used in combination such as mineral oils and poly-α-olefins, and a variety of additives generally used in lubricating oils (compositions) such as an antioxidant, a metal purifier, an oil agent, an anti-wear agent, a metal deactivator, a corrosion inhibitor, a rust inhibitor, a viscosity index improving agent, a pour-point depressant, a conductive agent, a dispersant, an antifoaming agent, and a hydrolysis inhibitor, which can be used in combination as appropriate unless the effect of the invention is impaired.

Examples of the antioxidant include phenol-based antioxidants, diphenylamines, alkylated phenyl-α-naphthylamine, phosphorus-based antioxidants, and sulfur-based compounds such as phenothiazine. The antioxidants can be used singly or in combination of two or more.

Examples of the anti-wear agent include phosphates, phosphites, acid phosphates, and amine salts of acid phosphates.

Examples of the rust inhibitor include dodecenylsuccinic acid half ester.

Examples of the metal deactivator include benzotriazole-based compounds and thiadiazole-based compounds.

Examples of the viscosity index improving agent include polyalkyl methacrylates, polyalkyl styrenes, and polybutene.

Examples of the pour-point depressant include polyalkyl methacrylates, polyalkyl styrenes, and polybutene, which are the viscosity index improving agents already mentioned.

Examples of the conductive agent include nonionic surfactants, ionic liquids, and phenylsulfonic acid.

Examples of the dispersant include polyalkenylsuccinimides, polyalkenylsuccinamides, polyalkenyl benzylamine, and polyalkenylsuccinic acid esters.

Examples of the hydrolysis inhibitor include alkyl glycidyl ether type epoxy compounds, glycidyl ester type epoxy compounds, alicyclic epoxy compounds, and carbodiimides.

As described above, according to the present invention, the lubricating oil includes a base oil that is a diester oil obtained by esterifying a particular aliphatic dihydric alcohol with two kinds of aliphatic monocarboxylic acids mixed at a particular ratio and has a controlled water content. It can be applied to a fluid dynamic bearing and a spindle motor to produce a long life motor that can start up even in a 0° C. environment and that can suppress the degradation of the lubricating oil even in high-temperature environment, with little evaporation.

### EXAMPLES

The present invention will be described in more detail with reference to Examples below. It should be noted that the present invention is not limited thereto.

### Base Oil of Lubricating Oil

### Example 1

A diester oil was obtained by esterifying 3-methyl-1,5-pentanediol (MPD) as an aliphatic dihydric alcohol with a mixture of n-decanoic acid (nC10 acid) and n-undecanoic acid (nC11 acid) as aliphatic monocarboxylic acids at a molar ratio of 50:50. The resultant diester oil was used as a base oil of lubricating oil.

### Example 2

A diester oil was obtained through esterification in the same manner as in Example 1 except that the molar ratio of the mixture of n-decanoic acid (nC10 acid) and n-undecanoic acid (nC11 acid) as aliphatic monocarboxylic acids was 70:30. The resultant diester oil was used as a base oil of lubricating oil.

### Example 3

A diester oil was obtained through esterification in the same manner as in Example 1 except that the molar ratio of the mixture of n-decanoic acid (nC10 acid) and n-undecanoic acid (nC11 acid) as aliphatic monocarboxylic acids was 30:70. The resultant diester oil was used as a base oil of lubricating oil.

### Example 4

A diester oil was obtained through esterification in the same manner as in Example 1 except that the molar ratio of the mixture of n-decanoic acid (nC10 acid) and n-undecanoic acid (nC11 acid) as aliphatic monocarboxylic acids was 90:10. The resultant diester oil was used as a base oil of lubricating oil.

### Example 5

A diester oil was obtained through esterification in the same manner as in Example 1 except that the molar ratio of the mixture of n-decanoic acid (nC10 acid) and n-undecanoic acid (nC11 acid) as aliphatic monocarboxylic acids was 40:60. The resultant diester oil was used as a base oil of lubricating oil.

### Example 6

A diester oil was obtained through esterification in the same manner as in Example 1 except that the molar ratio of the mixture of n-decanoic acid (nC10 acid) and n-undecanoic acid (nC11 acid) as aliphatic monocarboxylic acids was 20:80. The resultant diester oil was used as a base oil of lubricating oil.

### Comparative Example 1

A diester oil was obtained through esterification in the same manner as in Example 1 except that n-nonanoic acid (nC9 acid) alone was used as an aliphatic monocarboxylic acid. The resultant diester oil was used as a base oil of lubricating oil.

### Comparative Example 2

A diester oil was obtained through esterification in the same manner as in Example 1 except that n-decanoic acid (nC10 acid) alone was used as an aliphatic monocarboxylic acid. The resultant diester oil was used as a base oil of lubricating oil.

### Comparative Example 3

A diester oil was obtained through esterification in the same manner as in Example 1 except that n-undecanoic acid (nC11 acid) alone was used as an aliphatic monocarboxylic acid. The resultant diester oil was used as a base oil of lubricating oil.

### Comparative Example 4

Dioctyl sebacate (DOS) was used as a base oil of lubricating oil.

### Comparative Example 5

A mixture of dioctyl adipate (DOA) and dioctyl sebacate (DOS) at a ratio of 50:50 was used as a base oil of lubricating oil.

### Comparative Example 6

A diester oil was obtained through esterification in the same manner as in Example 1 except that the molar ratio of the mixture of n-decanoic acid (nC10 acid) and n-undecanoic acid (nC11 acid) as aliphatic monocarboxylic acids was 10:90. The resultant diester oil was used as a base oil of lubricating oil.

### Comparative Example 7

A diester oil was obtained by esterifying 3-methyl-1,5-pentanediol (MPD) as an aliphatic dihydric alcohol with a mixture of n-nonanoic acid (nC9 acid) and n-decanoic acid (nC10 acid) as aliphatic monocarboxylic acids at a ratio of 50:50. The resultant diester oil was used as a base oil of lubricating oil.

### Comparative Example 8

A diester oil was obtained by esterifying 3-methyl-1,5-pentanediol (MPD) as an aliphatic dihydric alcohol with a mixture of n-nonanoic acid (nC9 acid) and n-undecanoic acid (nC11 acid) as aliphatic monocarboxylic acids at a ratio of 50:50. The resultant diester oil was used as a base oil of lubricating oil.

In the methyl pentanediol diester oils of Examples 1 to 3 and Example 5, the mixing ratio between n-decanoic acid (nC10 acid) and n-undecanoic acid (nC11 acid) used and the compositions of the resultant diester oils are shown in Table 1. FIG. 2 shows variations in composition ratio of the three kinds of diester oils in relation to the mixing ratio (% by mole) of n-undecanoic acid [the MPD (3-methyl-1,5-pentanediol)/nC10 diester, the MPD/nC10-nC11 diester, the MPD/nC11 diester].

TABLE 1

| | Mixing ratio (mole %) | | Diester oil Composition ratio (%) | | |
|---|---|---|---|---|---|
| | nC10 | nC11 | nC10- | nC10- | nC11- |
| | acid | acid | nC10 | nC11 | nC11 |
| Example 2 | 70 | 30 | 47.6 | 42.7 | 9.7 |
| Example 1 | 50 | 50 | 25.0 | 49.8 | 25.2 |
| Example 5 | 40 | 60 | 15.3 | 47.5 | 37.2 |
| Example 3 | 30 | 70 | 8.8 | 41.5 | 49.7 |

[Measurement of Total Acid Number]

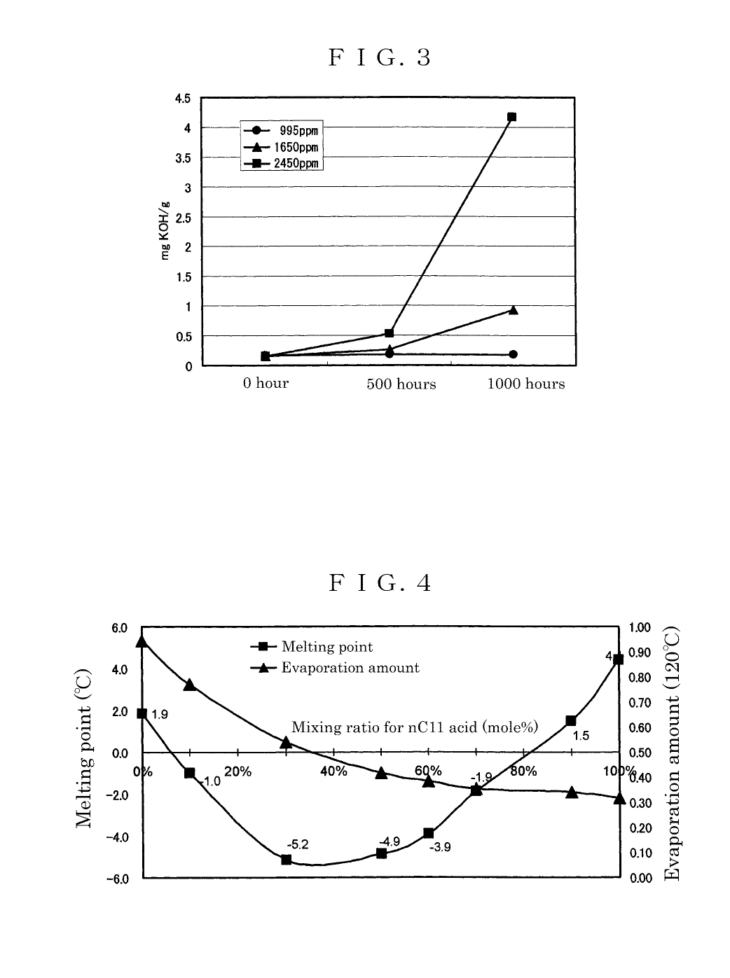

The water content in the base oil of lubricating oil prepared in Example 1 was adjusted to about 500 ppm to 2500 ppm. The samples were put into sealed containers and left in an 80° C. environment. The samples were taken out from the 80° C. environment after 500 hours and 1000 hours, and the total acid numbers of the diester oils were measured. The obtained results are shown in Table 2 and FIG. 3.

TABLE 2

| | Total acid number (mg KOH/g) | | |
|---|---|---|---|
| Water content | 0 | After 500 | After 1000 |
| in samples | hour | hours | hours |
| 470 ppm | 0.17 | 0.17 | 0.17 |
| 830 ppm | 0.17 | 0.17 | 0.18 |
| 995 ppm | 0.17 | 0.18 | 0.18 |
| 1650 ppm | 0.16 | 0.27 | 0.94 |
| 2450 ppm | 0.16 | 0.53 | 4.47 |

As shown in Table 2, in the samples having a water content of not more than 1000 ppm, the total acid number scarcely increased even after the samples were left in the 80° C. environment for 1000 hours. By contrast, in the samples having a water content of 1650 ppm and 2450 ppm, the total acid number increased after 500 hours, and degradation of the diester oil was observed.

As described above, it was demonstrated that deterioration of the base oil of lubricating oil could be suppressed by controlling the water content to not more than 1000 ppm.

[Evaluation of Wear Resistance of Lubricating Oil Containing Extreme-Pressure Additive]

The wear resistance of the lubricating oil including an extreme-pressure additive mixed with the base oil of lubricating oil was examined. Specifically, a total of 1% by mass of an antioxidant, a rust inhibitor, and a corrosion inhibitor with respect to the whole quantity of the lubricating oil was consistently added to the base oil of lubricating oil prepared in Example 1, and an extreme-pressure additive was further added in a variety of addition amounts (% by mass) with respect to the whole quantity of the lubricating oil. To evaluate the wear resistance of the lubricating oil with an extreme-pressure additive added thereto, a Shell four-ball wear test was conducted in accordance with ASTM D 2266 “Test Method for Wear Preventive Characteristics of Lubricating Grease (Four-Ball Method),” and variation in wear scar diameter (mm) were verified by varying the addition amount of the extreme-pressure additive. The results of the Shell four-ball wear test are shown in Table 3.

The extreme-pressure additives used in the wear test are two kinds of phosphorus-based extreme-pressure additives as shown below.

[Extreme-Pressure Additive A]

Resorcinol bis-diphenyiphosphate that is an aromatic phosphoric acid ester of Formula 4 below was used as an extreme-pressure additive A.

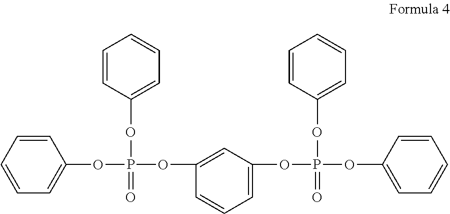 [SMILES: O=P(Oc1ccccc1)(Oc1ccccc1)Oc1cccc(OP(=O)(Oc2ccccc2)Oc2ccccc2)c1]

[Extreme-Pressure Additive B]

A mixed t-butyl phenyl phosphate (butylated phenyl phosphate) was used as an extreme-pressure additive B, which is an aromatic phosphoric acid ester of Formula 5 below that is a mixture of four ester compounds with the variable “a” varying from 0 to 3.

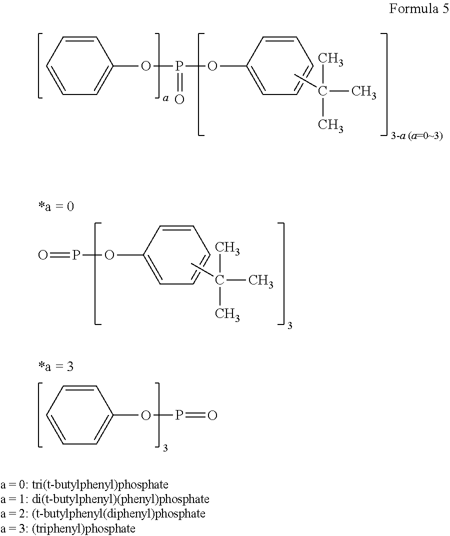

As shown in Table 3, in a range in which the addition amount of the extreme-pressure additive is not more than 1% by mass, the wear scar diameter is smaller when the lubricating oil including the extreme-pressure additive is used than when no lubricating oil is used. In both cases of the extreme-pressure additive A and the extreme-pressure additive B, the wear scar diameter decreases as the addition amount of the additive increases.

Considering that the lubricating oil is for use in a fluid dynamic bearing of a spindle motor, the preferable wear resistance is such that the average diameter of wear scars evaluated in the Shell four-ball wear test is, for example, not more than 0.7 mm.

Accordingly, based on the test results shown in Table 3, in order to achieve the average diameter of wear scars of not more than 0.7 mm, it is preferable that at least 0.1% by mass or more of the extreme-pressure additive be added, and it is more preferable that not less than 0.3% by mass be added

Although not shown in Table 3, the addition of 5% by mass or more of the extreme-pressure additive increases the amount of outgas produced from the lubricating oil, and contamination on the magnetic disk surface of the hard disk drive becomes significant. It is therefore preferable that the addition amount of the extreme-pressure additive be not more than 5% by mass.

wear scar diameter (mm)

TABLE 3

| | Extreme- | Addition | Wear scar |
|---|---|---|---|
| | pressure | amount | diameter |
| Base oil | additive | (mass %) | (mm) |
| None | None | 0 | 0.92 |
| (No Lubrication) | | | |
| Example 1 | Extreme- | 0.01 | 0.75 |
| | pressure | 0.05 | 0.74 |
| | additive A | 0.1 | 0.70 |
| | | 0.25 | 0.59 |
| | | 0.5 | 0.57 |
| | | 1 | 0.53 |
| | Extreme- | 0.25 | 0.76 |
| | pressure | 0.3 | 0.69 |
| | Additive B | 0.5 | 0.60 |
| | | 1 | 0.55 |

[Measurement of Total Acid Number of Lubricating Oil Containing Extreme-Pressure Additive]

The lubricating oil used in the foregoing [Evaluation of Wear Resistance of Lubricating Oil Containing Extreme-Pressure Additive] (a product obtained by consistently adding a total of 1% by mass of an antioxidant, a rust inhibitor, and a corrosion inhibitor with respect to the whole quantity of the lubricating oil to the base oil prepared in Example 1 and further adding an extreme-pressure additive) was used to prepare samples in which the water content in the lubricating oil was adjusted from 0 to 3000 ppm The total acid number of the diester oil was then measured. In the prepared samples, the addition amount of the extreme-pressure additive A or the extreme-pressure additive B was varied from 0.1% by mass to 10% by mass with respect to the whole quantity of the lubricating oil. The samples were put into sealed containers and left in an 80° C. environment. The samples were taken out from the 80° C. environment after 500 hours, and the total acid number of the diester oil was measured again. The total acid number (initial value) before the sample experiencing the 80° C. environment was compared with the total acid number after the sample experienced the 80° C. environment. A sample in which an increase in total acid number was not more than 0.1 mg KOH/g in relation to the initial value was evaluated as ◯, and a sample in which the increase exceeded 0.1 mg KOH/g was evaluated as X.

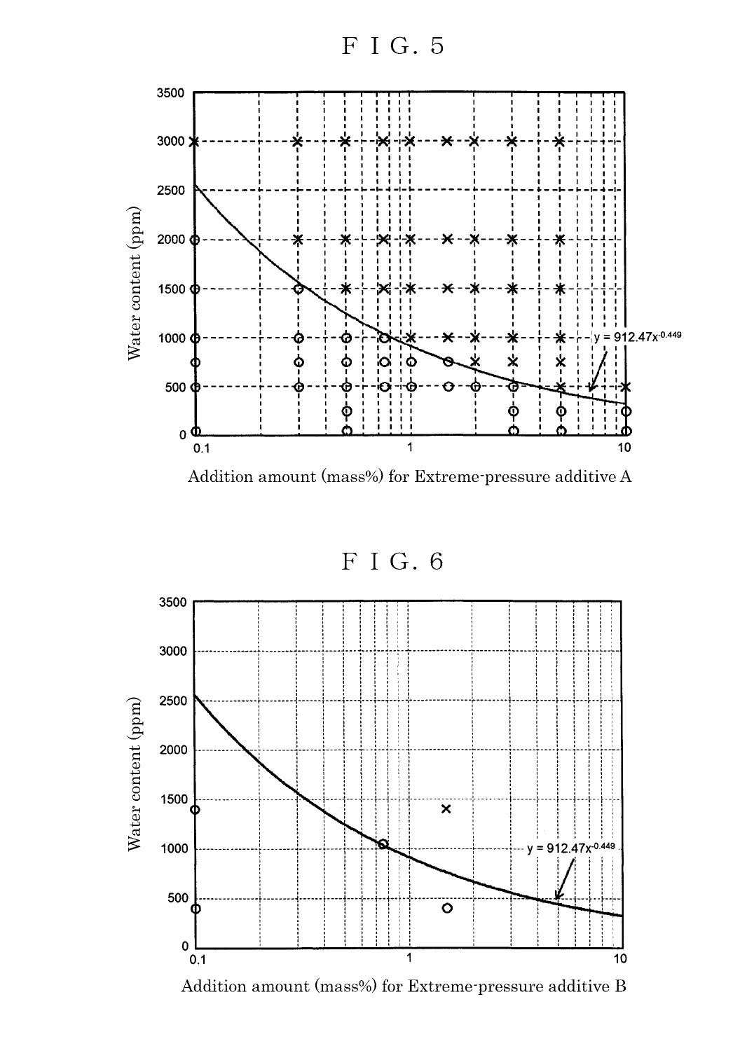

FIG. 5 and FIG. 6 show evaluations for an increase in total acid number with ◯ and X in the samples in which the water content in the lubricating oil (the vertical axis) was varied for different addition amounts of the extreme-pressure additive (the horizontal axis) (FIG. 5: extreme-pressure additive A, FIG. 6: extreme-pressure additive B).

The results from the two kinds of extreme-pressure additives were in good agreement. It was found that a preferable upper limit value y of the water content in the lubricating oil with respect to the addition amount of the extreme-pressure additive was represented by a regression curve of Expression (1):

y=912.47x^{-0.449} (1)

y: upper limit value of the water content (ppm) included in the lubricating oil

x: amount of the extreme-pressure additive contained in the lubricating oil (in % by mass with respect to the whole quantity of the lubricating oil).

In Expression (1), when the addition amount of the extreme-pressure additive is x [% by mass] and the water content in the lubricating oil is equal to or smaller than y [ppm] obtained by Expression (1), the lubricating oil shows small variation in total acid number after experiencing high-temperature environments (the increase is not more than 0.1 mg KOH/g). That is, the value y serves as a good indicator for obtaining a long-life lubricating oil even at high temperatures.

For the purpose of obtaining a long-life lubricating oil even at high temperatures, approximate upper limits of the water content can be set within a range that does not exceed the upper limit value y obtained by Expression (1). For example, the upper limit of the water content in the lubricating oil is set to not more than 1000 ppm when the addition amount of the extreme-pressure additive is not more than 0.8% by mass; the upper limit of the water content is not more than 500 ppm when the addition amount of the extreme-pressure additive is not more than 3% by mass; and the upper limit of the water content is not more than 300 ppm when the addition amount of the extreme-pressure additive is not more than 5% by mass. The stepwise setting of upper limits of water content as described above is convenient because they serve as criteria for obtaining a preferable lubricating oil without calculation of Expression (1).

The test described above has proved that the preferable upper limit value of the water content that can suppress an increase in total acid number under a high-temperature condition slightly varies between the case where an extreme-pressure additive is not added to the base oil of lubricating oil (see Table 2 and FIG. 3) and the case where it is added (see FIG. 5 and FIG. 6).

[Evaluation of Lubricating Oil]

A total of not more than 2% by mass of additives including 1% by mass of an amine-based antioxidant, 0.75% by mass of the extreme-pressure additive A, and not more than 0.25% by mass of a rust inhibitor (dodecenyl succinic acid half ester) and a benzotriazole-based metal deactivator together was blended with respect to the whole quantity of the lubricating oils produced in the foregoing Examples 1 to 6 and Comparative Examples 1 to 8. Lubricating oils of Examples 7 to 12 and Comparative Examples 9 to 16 were thus produced. The melting points and the pour points of these lubricating oils were measured by the procedure below. The kinds and the addition amount of additives blended were entirely the same in order to clarify the differences in effect due to the use of different base oil for lubricating oils.

A spindle motor including a fluid dynamic bearing and having the main part structure as shown in FIG. 1 was filled with the lubricating oil containing the additives as described above, and the performance as the lubricating oil for fluid dynamic bearing was evaluated as follows.

[Melting Point]

A differential scanning calorimeter (DSC) was used to determine the melting point corresponding to the temperature at which an endothermic reaction was completed when the lubricating oil transformed from solid to liquid after cooling the lubricating oil to the vicinity of −60° C. to temporarily freeze and then increasing the temperature at a rate of 2° C./min.

[Pour Point]

The pour point of the lubricating oil was measured in accordance with the pour point measurement method of JIS K2269.

[Rotation Startup Test (Low-Temperature Startup)]

After the spindle motor filled with the lubricating oil was left under a −40° C. environment for eight hours, the temperature was increased to 0° C. Voltage was thereafter applied to the motor to determine whether the motor could start.

As a criterion, the motor that steadily rotated within five seconds was evaluated as ◯, meaning that low-temperature startup is possible, otherwise the motor was evaluated as X, meaning that low-temperature startup is not possible.

[Motor Current Consumption]

After the spindle motor filled with the lubricating oil was cooled from room temperature (23° C.) to 0° C. and left for two hours, the motor was started, and the current value during steady rotation was measured. The current value was measured 60 seconds after the startup, considering the internal heat generation.

[Amount of Evaporation]

After continuously rotating the spindle motor filled with a known amount of the lubricating oil for 1000 hours in a 120° C. environment, the motor was disassembled, and the lubricating oil in the bearing was washed away with an organic solvent. The mass of the lubricating oil present in the bearing after the test was calculated from the change in mass before and after the washing. Based on this value, the change in mass of lubricating oil before and after the test was calculated and defined as the amount of evaporation.

[High-Temperature Rotation Startup Test]

After continuously rotating the spindle motor filled with the lubricating oil for 5000 hours in a 120° C. environment, it was determined whether the motor was able to start in a room temperature (23° C.) environment.

As a criterion, the motor that started rotating steadily within five seconds was evaluated as ◯, meaning that high-temperature startup is possible, otherwise the motor was evaluated as X, meaning that high-temperature startup is not possible.

[Shaft Rigidity]

The spindle motor including the fluid dynamic bearing filled with the lubricating oil was fixed to a vibrator and vibrated in the radial direction while the spindle motor was rotated. The maximum runout of the shaft was defined as shaft rigidity.

As a criterion, the initial shaft rigidity of the spindle motor filled with the lubricating oil was compared with the shaft rigidity after the continuous rotation in a 100° C. environment for 5000 hours. The motor with no change in shaft rigidity was evaluated as ◯, and the motor with a change (increase of numerical value) in shaft rigidity (deterioration of shaft rigidity) was evaluated as X.

[40° C. Kinetic Viscosity]

The 40° C. kinetic viscosity of the lubricating oil was measured using a viscometer in accordance with the kinetic viscosity measurement method of JIS K2283.

The obtained results are shown in Table 4 and Table 5 below. Table 4 also shows the water content of each lubricating oil used in the evaluation. As previously mentioned, it is desirable that the water content in the lubricating oil be not more than 1000 ppm in order to suppress degradation of the base oil in high-temperature environments and therefore, degradation of the lubricating oil. The water content can be adjusted to not more than 1000 ppm, if necessary, by heating the lubricating oil or reducing the pressure, or other processes. In Table 4, the value of motor current consumption is a relative value when the current consumption value in Comparative Example 12 using Comparative Example 4 (DOS) as a base oil of lubricating oil is 100, and the amount of evaporation is a relative value when the amount of evaporation in Comparative Example 12 using Comparative Example 4 (DOS) as a base oil of lubricating oil is 1.00. FIG. 4 shows variations in melting point and amount of evaporation with respect to the mixing ratio (% by mole) of n-undecanoic acid (nC11 acid).

TABLE 4

| | | | | | | | | | | | 40° C. Kinetic viscosity | | |
|---|---|---|---|---|---|---|---|---|---|---|---|---|---|
| | | | | | | | | | | | (cSt) | | |
| | | | | | | | | | Evaporation | | | After | |
| | | Ester composition | | | | | Melting | Pour | amount | Water | Initial | 5000 h | |
| | | for Base oil of lubricating oil | | | | | Point | Point | 120° C./ | content | value | 100° C. | Increase |
| | | Alcohol *¹ | Carboxylic acid *² | | | | [° C.] | [° C.] | 1000 h | ppm | (A) | (B) | (B − A) |
| Examples | 7 | MPD | nC₁₀ | 50 | nC₁₁ | 50 | −4.9 | −17.5 | 0.42 | 370 | 11.92 | 12.08 | 0.16 |
| | 8 | MPD | nC₁₀ | 70 | nC₁₁ | 30 | −5.2 | −20.0 | 0.54 | 435 | 11.26 | 11.44 | 0.18 |
| | 9 | MPD | nC₁₀ | 30 | nC₁₁ | 70 | −1.9 | −15.0 | 0.35 | 256 | 12.40 | 12.56 | 0.16 |
| | 10 | MPD | nC₁₀ | 90 | nC₁₁ | 10 | −1.0 | −17.8 | 0.77 | 271 | 10.81 | 10.99 | 0.18 |
| | 11 | MPD | nC₁₀ | 40 | nC₁₁ | 60 | −3.9 | −16.5 | 0.38 | 350 | 12.15 | 12.31 | 0.16 |
| | 12 | MPD | nC₁₀ | 20 | nC₁₁ | 80 | −0.3 | −12.5 | 0.34 | 281 | 12.45 | 12.60 | 0.15 |
| Comparative | 9 | MPD | nC₉ | 100 | | — | −15.9 | −32.0 | 2.00 | 408 | 8.87 | 8.88 | 0.01 |
| Examples | 10 | MPD | nC₁₀ | 100 | | — | 1.9 | −15.0 | 0.94 | 389 | 10.58 | 10.59 | 0.01 |
| | 11 | MPD | nC₁₁ | 100 | | — | 4.4 | −7.5 | 0.31 | 412 | 12.57 | 12.57 | 0.00 |
| | 12 | DOS | — | — | — | — | <−60 | <−60 | 1.00 | 288 | 11.54 | 11.60 | 0.06 |
| | 13 | DOA + DOS | — | — | — | — | <−60 | <−60 | 5.10 | 251 | 9.80 | 10.29 | 0.49 |
| | 14 | MPD | nC₁₀ | 10 | nC₁₁ | 90 | 1.5 | −10.0 | 0.34 | 358 | 12.50 | 12.63 | 0.13 |
| | 15 | MPD | nC₉ | 50 | nC₁₀ | 50 | −11.8 | −27.5 | 1.30 | 299 | 9.76 | 9.90 | 0.14 |
| | 16 | MPD | nC₉ | 50 | nC₁₁ | 50 | −11.7 | 11.7 | 0.76 | 281 | 10.90 | 11.20 | 0.30 |

*¹ MPD: 3-methyl-1,5-pentanediol DOS: dioctyl sebacate, DOA: dioctyl adipate
*² nC₁₀: n-decanoic acid, nC₁₁: n-undecanoic acid, nC₉: n-nonanoic acid The numerical values indicate mixing molar ratios.

TABLE 5

| | | | | | | | Low | | | High | |
|---|---|---|---|---|---|---|---|---|---|---|---|
| | | | | | | | temperature | Motor | Evaporation | temperature | Shaft |
| | | Ester composition | | | | | Rotation | current | amount | Rotation | rigidity |
| | | for Base oil of lubricating oil | | | | | Startup | consumption | 120° C./ | Startup | 100° C./ |
| | | Alcohol *¹ | Carboxylic acid *² | | | | 0° C. | 0° C. | 1000 h | 120° C./5000 h | 5000 h |
| Examples | 7 | MPD | nC₁₀ | 50 | nC₁₁ | 50 | ◯ | 95 | 0.42 | ◯ | ◯ |
| | 8 | MPD | nC₁₀ | 70 | nC₁₁ | 30 | ◯ | 95 | 0.54 | ◯ | ◯ |
| | 9 | MPD | nC₁₀ | 30 | nC₁₁ | 70 | ◯ | 97 | 0.35 | ◯ | ◯ |
| | 10 | MPD | nC₁₀ | 90 | nC₁₁ | 10 | ◯ | 94 | 0.77 | ◯ | ◯ |
| | 11 | MPD | nC₁₀ | 40 | nC₁₁ | 60 | ◯ | 95 | 0.38 | ◯ | ◯ |
| | 12 | MPD | nC₁₀ | 20 | nC₁₁ | 80 | ◯ | 97 | 0.34 | ◯ | ◯ |
| Comparative | 9 | MPD | nC₉ | 100 | — | — | ◯ | 91 | 2.00 | X | X |
| Examples | 10 | MPD | nC₁₀ | 100 | — | — | X | 94 | 0.94 | X | X |
| | 11 | MPD | nC₁₁ | 100 | — | — | X | 98 | 0.31 | ◯ | X |
| | 12 | DOS | — | — | — | — | ◯ | 100 | 1.00 | X | X |
| | 13 | DOA + DOS | — | — | — | — | ◯ | 92 | 5.10 | X | X |
| | 14 | MPD | nC₁₀ | 10 | nC₁₁ | 90 | X | 98 | 0.34 | ◯ | ◯ |
| | 15 | MPD | nC₉ | 50 | nC₁₀ | 50 | ◯ | 92 | 1.30 | X | ◯ |
| | 16 | MPD | nC₉ | 50 | nC₁₁ | 50 | ◯ | 95 | 0.76 | ◯ | X |

*¹ MPD: 3-methyl-1,5-pentanediol DOS: dioctyl sebacate, DOA: dioctyl adipate
*² nC₁₀: n-decanoic acid, nC₁₁: n-undecanoic acid, nC₉: n-nonanoic acid The numerical values indicate mixing molar ratios.

As shown in Table 5, with the lubricating oils in Examples 7 to 12, rotation startup was possible even in a low-temperature environment at 0° C., and rotation startup was possible even after continuous rotation in a 120° C. environment for 5000 hours. The amount of evaporation was small and the lifetime is satisfactory. The shaft rigidity did not change even after continuous rotation in a 120° C. environment for 5000 hours.

As shown in Table 4, in the lubricating oils in Examples 7 to 12 in the present invention, the increase in kinetic viscosity at 40° C. was in a range of 0.1 cSt to 0.2 cSt after continuous rotation in a 100° C. environment for 5000 hours.

Generally, the shaft rigidity of a spindle motor including a fluid dynamic bearing is directly proportional to the rotation speed and is inversely proportional to the third power of the radial bearing gap (amount). Accordingly, it is a change in radial bearing gap (amount) between the sleeve and the shaft that most affects the shaft rigidity. When a spindle motor is used for a long time, as the shaft comes into contact with the sleeve during startup and during stop, the sleeve and the shaft gradually wear, though slightly. As a result, the size of radial bearing gap between the sleeve and the shaft increases, and the shaft rigidity decreases (the displacement representing shaft rigidity increases). The spindle motor eventually becomes unable to function.

In the spindle motors using the lubricating oils of Examples 7 to 12 of the present invention, the obtained result shows that the shaft rigidity does not decrease even when the radial bearing gap (amount) seems to increase due to long-term operation of the spindle motor. This is possibly because the deterioration in shaft rigidity is suppressed by the change (increase) in kinetic viscosity of the lubricating oil in long-term operation.

As described above, the lubricating oil of the present invention prevents reduction in shaft rigidity because the kinetic viscosity adequately increases over long-term use. For example, the kinetic viscosity of the lubricating oil according to the present invention is preferably such that an increase in kinetic viscosity at 40° C. after continuous rotation in a 100° C. environment for 5000 hours falls in a range of 0.1 cSt to 0.2 cSt. Noting the relationship between the shaft rigidity and the kinetic viscosity for the lubricating oils of Comparative Examples 9 to 16, the obtained result shows that the shaft rigidity does not change in Comparative Examples 14 and 15 in which an increase in kinetic viscosity falls in a range of 0.1 cSt to 0.2 cSt, and when an increase in kinetic viscosity falls below this range or exceeds this range, the shaft rigidity changes.

On the other hand, as for the lubricating oils in Comparative Examples 9, 12, 13, and 15, although rotation startup was possible in a 0° C. environment, the amount of evaporation in a 120° C. environment was large, and the lubricating oil was exhausted in less than 5000 hours during continuous rotation in a 120° C. environment. Thus, the spindle motor stopped.

The lubricating oil in Comparative Example 10 froze in a 0° C. environment to disable rotation startup and was exhausted in less than 5000 hours during continuous rotation in a 120° C. environment. Thus, the spindle motor stopped.

The lubricating oils in Comparative Examples 11 and 14 exhibited a sufficient lifetime in a 120° C. environment but froze in a 0° C. environment to disable rotation startup.

In Comparative Examples 11 and 16, the shaft rigidity decreased after continuous rotation in a 120° C. environment for 5000 hours.

As described above, according to the present invention, a lubricating oil including, as a base oil, a methyl pentanediol diester obtained by combining two kinds of fatty acids is used in a fluid dynamic bearing and a spindle motor. Thus, it is possible to achieve a spindle motor that is capable of rotation startup even in low-temperature environments (0° C.), capable of rotation startup with little evaporation even when experiencing high-temperature environments (120° C.), and capable of achieving a longer lifetime of a hard disk drive.

Although best embodiments have been described in detail above, the present invention is not limited to the foregoing embodiments, and modifications and improvement within a scope that can achieve the object of the present invention are included in the present invention.

1. A fluid dynamic bearing comprising:
a dynamic pressure groove on a facing surface of at least one of a rotating member and a fixed member facing each other with a predetermined gap therebetween filled with a lubricating oil, wherein
the lubricating oil contains a methyl pentanediol diester obtained by esterifying 3-methyl-1,5-pentanediol with a fatty acid including n-decanoic acid and n-undecanoic acid at a molar ratio ranging from 90:10 to 20:80, and
the lubricating oil has a water content of not more than 1000 ppm.

2. A fluid dynamic bearing comprising:
a dynamic pressure groove on a facing surface of at least one of a rotating member and a fixed member facing each other with a predetermined gap therebetween filled with a lubricating oil, wherein
the lubricating oil contains a methyl pentanediol diester obtained by esterifying 3-methyl-1,5-pentanediol with a fatty acid including n-decanoic acid and n-undecanoic acid at a molar ratio ranging from 90:10 to 20:80, and 0.1% to 5% by mass of an extreme-pressure additive with respect to the whole quantity of the lubricating oil, and
the lubricating oil has a water content in ppm of not more than an upper limit value y represented by Expression (1):
y=912.47x^{-0.449} (1)
y: the upper limit value of the water content (ppm) in the lubricating oil
x: the amount of the extreme-pressure additive contained in the lubricating oil (in % by mass with respect to the whole quantity of the lubricating oil).

3. The fluid dynamic bearing according to claim 2, wherein
the amount of the extreme-pressure additive contained is 0.3% to 5% by mass with respect to the whole quantity of the lubricating oil.

4. The fluid dynamic bearing according to claim 2, wherein
a relationship between the amount of the extreme-pressure additive contained in the lubricating oil and the water content in the lubricating oil satisfy one of conditions (a) to (c) below:
(a) the amount of the extreme-pressure additive contained is not more than 0.8% by mass and the water content in the lubricating oil is not more than 1000 ppm;
(b) the amount of the extreme-pressure additive contained is not more than 3% by mass and the water content in the lubricating oil is not more than 500 ppm; and
(c) the amount of the extreme-pressure additive contained is not more than 5% by mass and the water content in the lubricating oil is not more than 300 ppm.

5. The fluid dynamic bearing according to claim 2, wherein
the extreme-pressure additive is a phosphorous-based extreme-pressure additive.

6. The fluid dynamic bearing according to claim 1, wherein
the molar ratio between n-decanoic acid and n-undecanoic acid ranges from 30:70 to 70:30.

7. The fluid dynamic bearing according to claim 1, wherein
the molar ratio between n-decanoic acid and n-undecanoic acid is set at 50:50.

8. A spindle motor comprising the fluid dynamic bearing as claimed in claim 1.

9. A lubricating oil for fluid dynamic bearings comprising:
a methyl pentanediol diester obtained by esterifying 3-methyl-1,5-pentanediol with a fatty acid, wherein
the fatty acid includes n-decanoic acid and n-undecanoic acid at a molar ratio ranging from 90:10 to 20:80, and
the lubricating oil has a water content of not more than 1000 ppm.

10. A lubricating oil for fluid dynamic bearings comprising:
a methyl pentanediol diester obtained by esterifying 3-methyl-1,5-pentanediol with a fatty acid; and
an extreme-pressure additive, wherein
the fatty acid includes n-decanoic acid and n-undecanoic acid at a molar ratio ranging from 90:10 to 20:80,
the amount of the extreme-pressure additive contained is 0.1% to 5% by mass with respect to the whole quantity of the lubricating oil, and
the lubricating oil has a water content in ppm of not more than an upper limit value y represented by Expression (1):
y=912.47x^{-0.449} (1)
y: the upper limit value of the water content (ppm) in the lubricating oil
x: the amount of the extreme-pressure additive contained in the lubricating oil (in % by mass with respect to the whole quantity of the lubricating oil).

11. The lubricating oil for fluid dynamic bearings according to claim 10, wherein
the amount of the extreme-pressure additive contained is 0.3% to 5% by mass with respect to the whole quantity of the lubricating oil.

12. The lubricating oil for fluid dynamic bearings according to claim 11, wherein
a relationship between the amount of the extreme-pressure additive contained in the lubricating oil and the water content in the lubricating oil satisfy one of conditions (a) to (c) below:
(a) the amount of the extreme-pressure additive contained is not more than 0.8% by mass and the water content in the lubricating oil is not more than 1000 ppm;
(b) the amount of the extreme-pressure additive contained is not more than 3% by mass and the water content in the lubricating oil is not more than 500 ppm; and
(c) the amount of the extreme-pressure additive contained is not more than 5% by mass and the water content in the lubricating oil is not more than 300 ppm.

13. The lubricating oil for fluid dynamic bearings according to claim 9, wherein
the extreme-pressure additive is a phosphorous-based extreme-pressure additive.

14. The lubricating oil for fluid dynamic bearings according to claim 10, wherein
the extreme-pressure additive is a phosphorous-based extreme-pressure additive.

15. The fluid dynamic bearing according to claim 2, wherein
the molar ratio between n-decanoic acid and n-undecanoic acid ranges from 30:70 to 70:30.

16. The fluid dynamic bearing according to claim 2, wherein
the molar ratio between n-decanoic acid and n-undecanoic acid is set at 50:50.

17. A spindle motor comprising the fluid dynamic bearing as claimed in claim 2.
